(19) United States
(12) Patent Application Publication
(10) Pub. No.: US 2018/0369059 A1
(43) Pub. Date: Dec. 27, 2018

(54) DETACHABLE TRAY DEVICE FOR A WALKER AND METHOD

(71) Applicant: Luthia Shirley, Fort Erie (CA)

(72) Inventor: Luthia Shirley, Fort Erie (CA)

(21) Appl. No.: 15/631,695

(22) Filed: Jun. 23, 2017

(51) Int. Cl. A61H 3/04

(52) U.S. Cl. CPC A61H 3/04; A61H 2003/004

(57) ABSTRACT

A detachable tray device for a walker having a seat portion. The detachable tray device may include a holding tray configured to hold items to be transported by the walker, the holding tray may include a base panel, a front wall, a rear wall, and a pair of side walls, each wall connected to and extending outwardly from the base panel. The base panel may include a bottom surface adapted to rest on the seat portion of the walker. In addition, a removable tray insert adapted to be insertable into the holding tray may be provided. The removable tray insert may include at least one storage compartment adapted to hold at least one of the items to be transported by the walker.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of assistive walker accessories of existing art and more specifically relates to support racks for walkers with arrangements of plural receptacles.

### RELATED ART

The use of a walker can increase the safety and freedom of walking independently; however, increased challenges arise when using the walker in a home setting. Persons with limited mobility often experience difficulties carrying or transporting objects while using the walker. Some attempt to utilize the seat of a wheeled walker as a support surface for food, beverages, eye glasses, and similar personal items. Unfortunately, the practice often results in accidental drops and spills as items balanced on the seat surface can shift and fall as the walker moves. A convenient, durable, and low-cost system to assist a user to transport personal items while using a wheeled walker would benefit many.

U.S. Pat. No. 4,659,099 to Malone relates to a food and item tray for a walker and a wheelchair. The described food and item tray for a walker and a wheelchair includes a food and item tray for a walker and a wheelchair and consists of a lightweight basket that has a plurality of mounting clamps for attachment to the walker and the wheelchair and a removable lightweight housing supported in the basket. The housing has a plurality of built-in variously sized compartments for holding items such as a dish, cup, silverware and the like which will prevent the items from spilling out therefrom. One shortcoming of the apparatus of Malone is the sole reliance on engagement with framework of the walker device for support of the device. The disclosed device of Malone relies entirely on frictional engagement with the frame of the walker without a secondary means for preventing the tray from dislodging from the frame.

### SUMMARY OF THE INVENTION

In view of the foregoing disadvantages inherent in the known support racks for walkers with arrangements of plural receptacles art, the present disclosure provides a novel detachable tray device for a walker and method. The general purpose of the present disclosure, which will be described subsequently in greater detail, is to provide a detachable tray device for a walker and method.

In accordance with a preferred embodiment hereof, this invention provides a detachable tray device for a walker having a seat portion. The detachable tray device may include a holding tray configured to hold items to be transported by the walker, the holding tray may include a base panel, a front wall, a rear wall, and a pair of side walls, each wall connected to and extending outwardly from the base panel. The base panel may include a bottom surface adapted to rest on the seat portion of the walker. The base panel may be rectangular.

A stabilizer configured to stabilize the holding tray on the seat portion during movement of the walker may be provided. The stabilizer may include a hook-shaped portion adapted to engage a backrest bar of the walker and a connecting member adapted to join the hook-shaped portion with the rear wall of the holding tray. Moreover, the stabilizer may include a releasable retainer configured to releasably retain the hook-shaped portion adjacent the backrest bar of the walker. The releasable retainer may include an elongated blocking bar adapted to block the disengagement of the hook-shaped portion from the backrest bar of the walker. A first-end portion of the blocking bar may removably engage a socket mounted to the connecting member. The releasable retainer may include a user-operable threaded fastener adapted to removably fasten a second-end portion of the blocking bar to the hook-shaped portion of the releasable retainer. The connecting member may also include a storage pocket adapted to store at least one of the items to be transported by the walker.

In addition, a removable tray insert adapted to be insertable into the holding tray may be provided. The removable tray insert may include at least one storage compartment adapted to hold at least one of the items to be transported by the walker. The compartments of the removable tray insert may include one or more recessed compartments adapted to receive a cylindrical beverage container. Further, the removable tray insert may include at least two storage compartments, each one adapted to hold at least one of the items to be transported by the walker. Even further, the at least one storage compartment of the removable tray insert may include a quadrilateral shape. Moreover, embodiments of the removable tray insert may include at least four storage compartments each one adapted to hold at least one of the items to be transported by the walker. In one embodiment of such a detachable tray device, two of the at least four storage compartments of the removable tray insert may each be adapted to receive a cylindrical beverage container; and two of the at least four storage compartments of the removable tray insert may each include recessed compartments having a quadrilateral shape.

Additionally, it provides such a detachable tray device, wherein the pair of side walls include opposing outward slopes. Also, it provides such a detachable tray device, wherein the front wall is orthogonally positioned relative to the base panel. In addition, it provides such a detachable tray device, further including a first set of removable fasteners configured to removably fasten the holding tray to the connecting member of the stabilizer. The device may further include a second set of removable fasteners configured to removably fasten the removable tray insert to the holding tray.

Furthermore, it provides such a detachable tray device, wherein the removable tray insert may include a transverse width extending between the pair of side walls. Even further, it provides such a detachable tray device, wherein the base panel, the front wall, the rear wall, and the pair of side walls are formed as a single unit. Even further, it provides such a detachable tray device, wherein the detachable tray device is constructed from at least one rigid plastic and may comprise scalloped edges. Additionally, such a detachable tray device may further include a set of instructions wherein the detachable tray device is arranged as a kit.

In accordance with another preferred embodiment hereof, this invention provides a method relating to the use of a detachable tray device, the method may include the steps of: providing a holding tray configured to hold items to be transported by the walker, the holding tray including a base panel, a front wall, a rear wall, and a pair of side walls, each wall connected to and extending outwardly from the base panel, the base panel including a bottom surface adapted to rest on a seat portion of the walker; providing a stabilizer configured to stabilize the holding tray on the seat portion during movement of the walker, the stabilizer including a hook-shaped portion adapted to engage a backrest bar of the walker and a connecting member adapted to join the hook-shaped portion with the rear wall, of the holding tray; resting the bottom surface of holding tray on the on the seat portion of the walker; and engaging the hook-shaped portion of the stabilizer on the backrest bar of the walker to stabilize the holding tray on the seat portion during movement of the walker. Even further, it provides such a method, further including the steps of: providing a releasable retainer to releasably retain the hook-shaped portion of the stabilizer adjacent the backrest bar of the walker; and engaging the releasable retainer to releasably retain the hook-shaped portion of the stabilizer adjacent the backrest bar of the walker.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a detachable tray device for a walker and method, constructed and operative according to the teachings of the present disclosure.

FIG. 1 is a perspective view of the detachable tray device during an ‘in-use’ condition, according to an embodiment of the disclosure.

FIG. 2 is a front perspective view of the detachable tray device of FIG. 1, according to an embodiment of the present disclosure.

FIG. 3 is a rear perspective view of the detachable tray device of FIG. 1, according to an embodiment of the present disclosure.

FIG. 4 is a side view of the detachable tray device of FIG. 1, according to an embodiment of the present disclosure.

FIG. 5 is a top view of the detachable tray device of FIG. 1, according to an embodiment of the present disclosure.

FIG. 6 is an exploded view of the detachable tray device of FIG. 1, according to an embodiment of the present disclosure.

FIG. 7 is a flow diagram illustrating a method of use for the detachable tray device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a support racks for walkers with arrangements of plural receptacles and more particularly to a detachable tray device for a walker and method as used to assist individuals transport items using a wheeled walker.

Generally, the detachable tray device of the present disclosure is designed to overcome a number of difficulties commonly encountered by persons with limited mobility. The device enables a disabled user to carry or transport objects, such as food, beverages, eye glasses, etc., by means of a detachable tray fixed to a wheeled walker. The device functions as an adaptable table, assisting users to transport personals plus eat meals at any location. The detachable tray includes raised edges to prevent slippage and an insert having several recessed compartments to hold containers for food and drinks as well as a pocket for napkins, etc. The device is easy to attach and detach making it a conveniently-portable accessory. The unit is constructed from a material that is both easy to clean and is light weight.

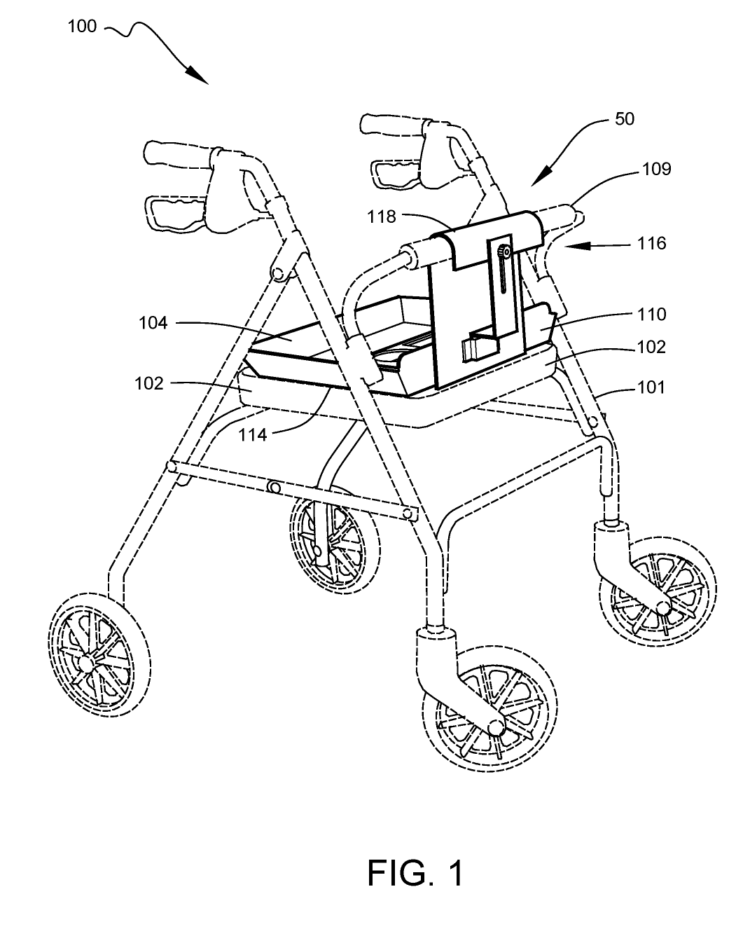

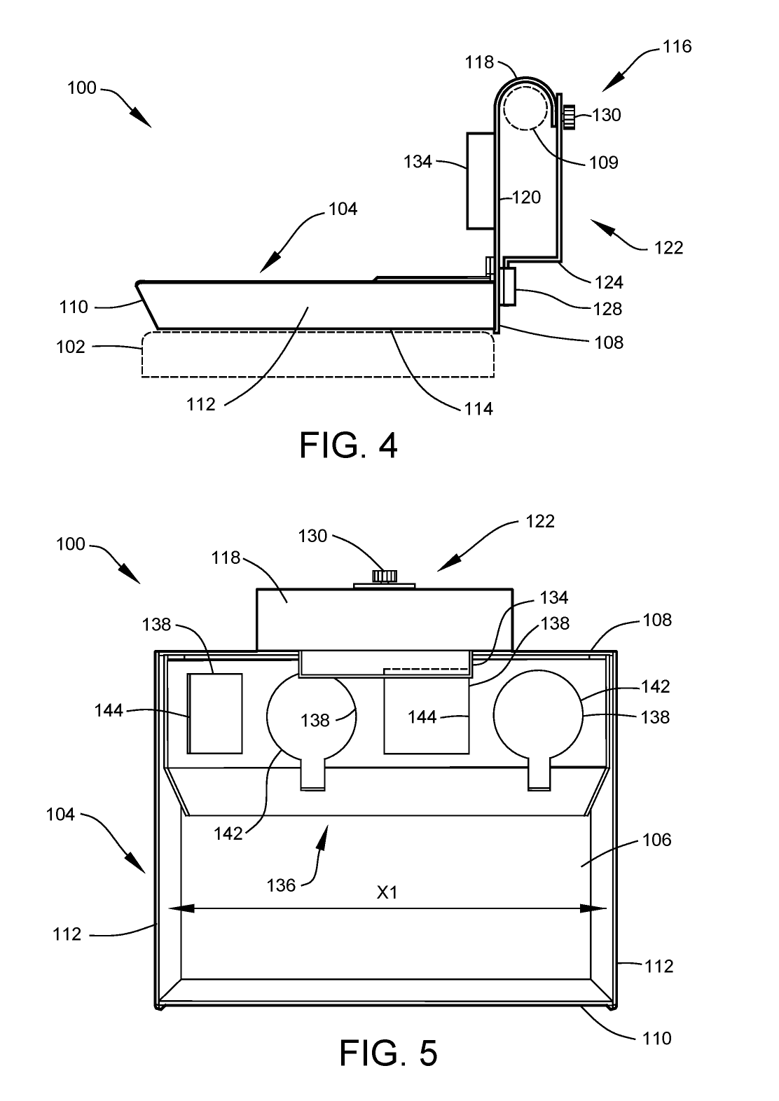

Referring now more specifically to the drawings by numerals of reference, there is shown in FIGS. 1-6, various views of a detachable tray device 100.

FIG. 1 shows a detachable tray device 100 during an ‘in-use’ condition 50, according to an embodiment of the present disclosure. Here, the detachable tray device 100 may be beneficial for assisting individuals transport items using a wheeled walker 101. As illustrated, the detachable tray device 100 is configured for use with a walker 101 having a seat portion 102. The detachable tray device 100 may include a holding tray 104 configured to hold items 103 to be transported by the walker 101. The holding tray 104 may include a base panel 106, a front wall 108, a rear wall 110, and a pair of side walls 112, each wall connected to and extending outwardly from the base panel 106. The base panel 106 may include a bottom surface 114 adapted to rest on the seat portion 102 of the walker 101. The front wall 108, the rear wall 110, and the side walls 112 form a set of raised edges to prevent slippage of items placed in the tray. The base panel 106 may be rectangular, as shown.

A stabilizer 116 configured to stabilize the holding tray 104 on the seat portion 102 during movement of the walker 101 may be provided. The stabilizer 116 may include a hook-shaped portion 118 adapted to engage a backrest bar 109 of the walker 101 and an integral connecting member 120 adapted to join the hook-shaped portion 118 with the rear wall 110 of the holding tray 104, as shown. Upon reading this specification, it should be appreciated that, under appropriate circumstances, considering such issues as user preferences, design preference, structural requirements, marketing preferences, cost, available materials, technological advances, etc., other stabilizer arrangements such as, for example, flexible leashes, clamping mechanisms to clamp the tray to the seat portion, frictional surface materials applied to the underside of the tray, etc., may be sufficient.

The stabilizer 116 may include a releasable retainer 122 adapted to help retain the hook-shaped portion 118 in position over the backrest bar 109 of the walker 101. The releasable retainer 122 may include an elongated blocking bar 124 adapted to block the disengagement of the hook-shaped portion 118 from the backrest bar of the walker 101. A first-end portion 126 of the blocking bar 124 may removably engage a socket 128 mounted to the connecting member 120, as shown. The releasable retainer 122 may include a user-operable threaded fastener 130 adapted to fasten a second-end portion 132 of the blocking bar 124 to the hook-shaped portion 118 of the releasable retainer 122. The threaded fastener 130 may include a threaded post 158 projecting outwardly from the hook-shaped portion 118 adapted to pass through a slotted opening 154 of the blocking bar 124. An internally-threaded knob 160 is provided to engage the threaded post 158 after passage through the blocking bar 124, thus retaining the assembly in place. Upon reading this specification, it should be appreciated that, under appropriate circumstances, considering such issues as user preferences, design preference, structural requirements, marketing preferences, cost, available materials, technological advances, etc., other retainer arrangements such as, for example, hinged blocking bars, leashes, clamps hook and loop retainers, etc., may be sufficient.

The connecting member 120 may also include a storage pocket 134 adapted to store at least one of the items to be transported by the walker 101. For example, the storage pocket 134 may be used to hold napkins or similarly-shaped items.

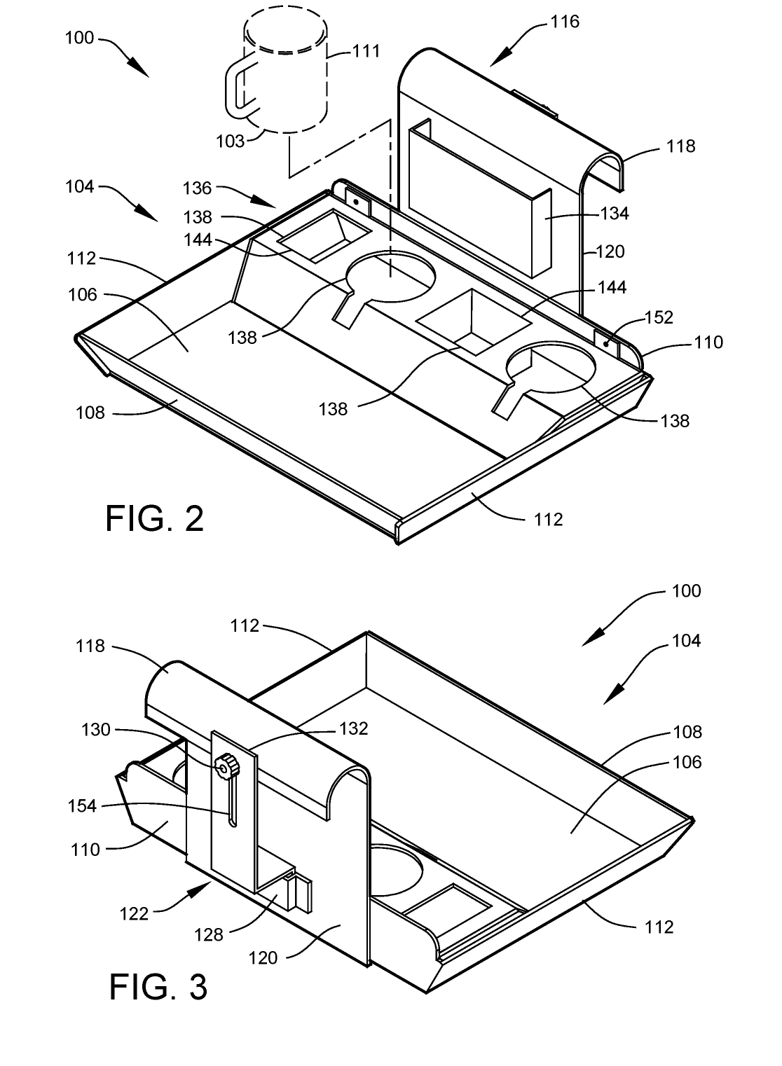

In addition, a removable tray insert 136 adapted to be insertable into the holding tray 104 may be provided. The removable tray insert 136 may include at least one storage compartment 138 adapted to hold at least one of the items to be transported by the walker 101. The compartments of the removable tray insert 136 may include one or more recessed compartments 142 adapted to receive a cylindrical beverage container 111 (see FIG. 2). The recessed compartments 142 may include features such as a notch to accommodate the handle of a mug. Further, the removable tray insert 136 may include at least two storage compartments 138, as shown, each one adapted to hold at least one of the items to be transported by the walker 101. Even further, the storage compartments 138 of the removable tray insert 136 may include a rectangular or square quadrilateral shape 144. Moreover, embodiments of the removable tray insert 136 may include at least four storage compartments 138 each one adapted to hold at least one of the items to be transported by the walker 101. In one embodiment of such a detachable tray device 100, two of the at least four storage compartments 138 of the removable tray insert 136 may each be adapted to receive a cylindrical beverage container 111 and two of the at least four storage compartments 138 of the removable tray insert 136 may each have a rectangular or square quadrilateral shape 144, as shown. Upon reading this specification, it should be appreciated that, under appropriate circumstances, considering such issues as user preferences, design preference, structural requirements, marketing preferences, cost, available materials, technological advances, etc., other insert arrangements such as, for example, compartments with closable lids, compartments configured to hold specific medical devices, integration of electronics such as radios, lights, monitoring devices, etc., may be sufficient.

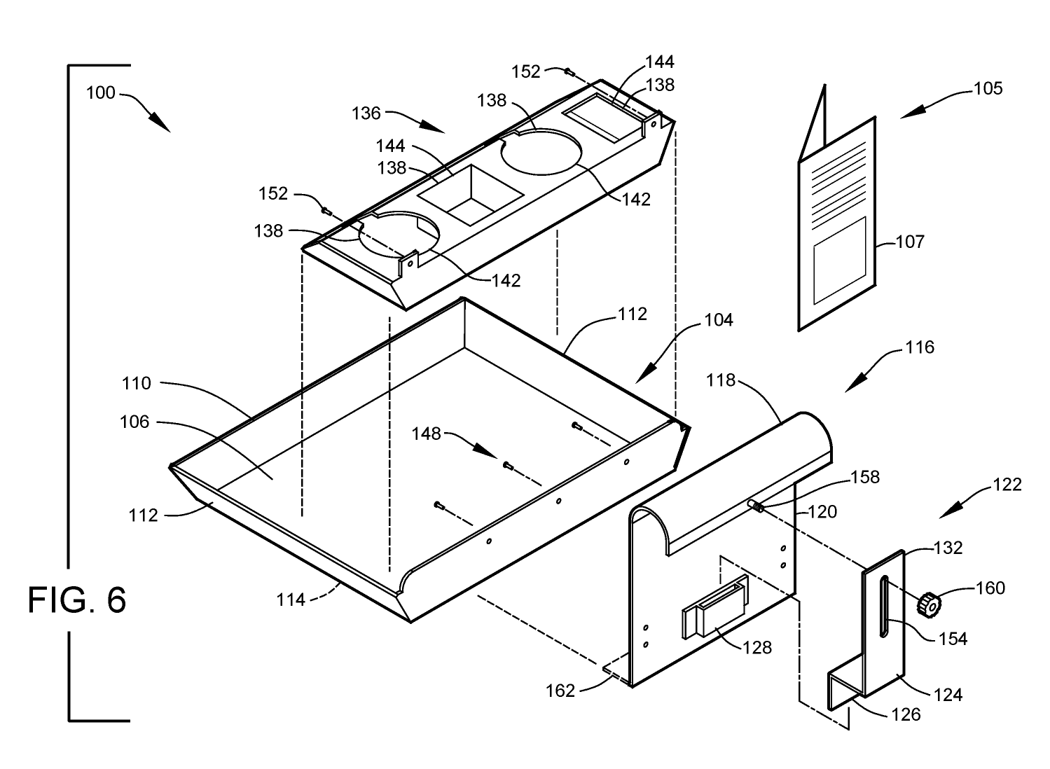

In one embodiment of the detachable tray device 100, the pair of side walls 112 of the tray may include opposing outward slopes, as shown. In addition, the detachable tray device 100 may further include a first set of removable fasteners 148 configured to removably fasten the holding tray 104 to the connecting member 120 of the stabilizer 116. This feature allows the stabilizer 116 to be replaced when another type of tray insert is required. The front wall 108 may orthogonally positioned relative to the base panel 106 to assist in aligning the front wall 108 and the connecting member 120 when the assemblies are joined. The connecting member 120 may include a vertically-spaced arrangement of receivers adapted to receive the first set of removable fasteners 148, thus enabling the distance between the hook-shaped portion 118 and bottom surface 114 to be adjusted, as required. In some embodiments, the base of the connecting member 120 may include a support flange 162, as shown in FIG. 6.

The detachable tray device 100 may further include a second set of removable fasteners 152 configured to removably fasten the removable tray insert 136 to the holding tray 104 (see FIG. 6). This feature allows the removable tray insert 136 to be removed when not in use, or replaced with another type of tray insert, if needed.

The removable tray insert 136 may have a transverse width X1 extending between the opposing pair of side walls, as shown. Even further, the base panel 106, the front wall 108, the rear wall 110, and the pair of side walls 112 of the removable tray insert 136 may be formed as a single unit, as shown. The detachable tray device may be constructed from a material that is both easy to clean and is light weight. For example, the detachable tray device 100 may be constructed from at least one rigid plastic.

According to one embodiment, the detachable tray device 100 may be arranged as a kit 105. In particular, the detachable tray device 100 may further include a set of instructions 107. The instructions 107 may detail functional relationships in relation to the structure of the detachable tray device 100 such that the detachable tray device 100 can be used, maintained, or the like, in a preferred manner.

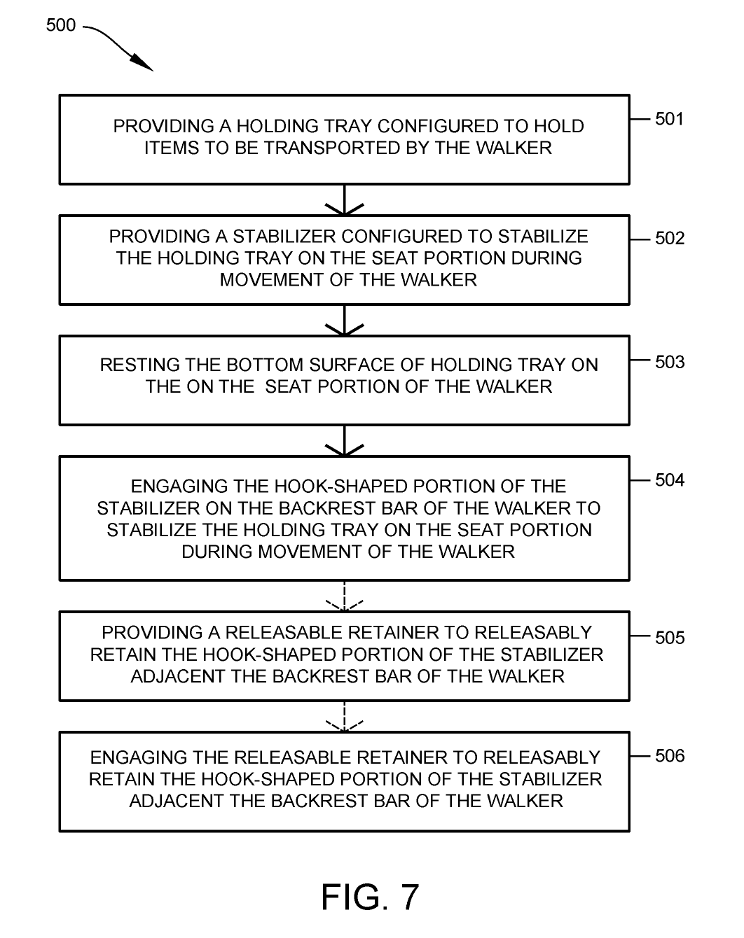

FIG. 7 is a flow diagram illustrating a method 500 relating to the use of the detachable tray device 100, according to an embodiment of the present disclosure. In particular, the method 500 may include one or more components or features of the detachable tray device 100 as described above. As illustrated, the method 500 may include the steps of: step one 501, providing a holding tray configured to hold items to be transported by the walker, the holding tray including a base panel, a front wall, a rear wall, and a pair of side walls, each wall connected to and extending outwardly from the base panel, the base panel including a bottom surface adapted to rest on a seat portion of the walker; step two 502, providing a stabilizer configured to stabilize the holding tray on the seat portion during movement of the walker, the stabilizer including a hook-shaped portion adapted to engage a backrest bar of the walker and a connecting member adapted to join the hook-shaped portion with the rear wall, of the holding tray; step three 503, resting the bottom surface of holding tray on the on the seat portion of the walker; and step four 504, engaging the hook-shaped portion of the stabilizer on the backrest bar of the walker to stabilize the holding tray on the seat portion during movement of the walker.

Even further, method 500 further includes the steps of: step five 505, providing a releasable retainer to releasably retain the hook-shaped portion of the stabilizer adjacent the backrest bar of the walker; and step six 506, engaging the releasable retainer to releasably retain the hook-shaped portion of the stabilizer adjacent the backrest bar of the walker.

It should be noted that steps 505 and 506 are optional steps and may not be implemented in all cases. Optional steps of method 500 are illustrated using dotted lines in FIG. 7 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods relating to the detachable tray device 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1) A detachable tray device for a walker, the detachable tray device comprising:
a holding tray configured to hold items to be transported by the walker, the holding tray including a base panel, a front wall, a rear wall, and a pair of side walls, each wall connected to and extending outwardly from the base panel, the base panel including a bottom surface adapted to rest on a seat portion of the walker;
a stabilizer configured to stabilize the holding tray on the seat portion during movement of the walker, the stabilizer including a hook-shaped portion adapted to engage a backrest bar of the walker and a connecting member adapted to join the hook-shaped portion with the rear wall of the holding tray; and
a removable tray insert adapted to be insertable into the holding tray, the removable tray insert including at least one storage compartment adapted to hold at least one of the items to be transported by the walker.

2. The detachable tray device of claim 1, wherein the stabilizer comprises a releasable retainer configured to releasably retain the hook-shaped portion adjacent the backrest bar of the walker.

3. The detachable tray device of claim 2, wherein the releasable retainer comprises:
a blocking bar adapted to block the disengagement of the hook-shaped portion from the backrest bar of the walker;
coupled to the connecting member, a socket configured to removably receive a first-end portion of the blocking bar; and
a user-operable threaded fastener adapted to removably fasten a second-end portion of the blocking bar to the hook-shaped portion of the releasable retainer.

4. The detachable tray device of claim 1, wherein the connecting member comprises a storage pocket adapted to store at least one of the items to be transported by the walker.

5. The detachable tray device of claim 1, wherein the base panel is rectangular.

6. The detachable tray device of claim 1, wherein the at least one storage compartment of the removable tray insert comprises a recessed compartment adapted to receive a cylindrical beverage container.

7. The detachable tray device of claim 1, wherein the removable tray insert comprises at least two storage compartments each one adapted to hold at least one of the items to be transported by the walker.

8. The detachable tray device of claim 1, wherein the at least one storage compartment of the removable tray insert comprises a quadrilateral shape.

9. The detachable tray device of claim 1, wherein
the removable tray insert comprises at least four storage compartments each one adapted to hold at least one of the items to be transported by the walker;
two of the at least four storage compartments of the removable tray insert are each adapted to receive a cylindrical beverage container; and
two of the at least four storage compartments of the removable tray insert each comprise recessed compartments having a quadrilateral shape.

10. The detachable tray device of claim 9, wherein the pair of side walls comprise opposing outward slopes.

11. The detachable tray device of claim 1, wherein the front wall is orthogonally positioned relative to the base panel.

12. The detachable tray device of claim 1, further comprising a first set of removable fasteners configured to removably fasten the holding tray to the connecting member of the stabilizer.

13. The detachable tray device of claim 1, further comprising a second set of removable fasteners configured to removably fasten the removable tray insert to the holding tray.

14. The detachable tray device of claim 1, wherein the removable tray insert comprises a transverse width extending between the pair of side walls.

15. The detachable tray device of claim 1, wherein the base panel, the front wall, the rear wall, and the pair of side walls are formed as a single unit.

16. The detachable tray device of claim 1, wherein the detachable tray device is constructed from at least one rigid plastic.

17. A detachable tray device for a walker, the detachable tray device comprising:
a holding tray configured to hold items to be transported by the walker, the holding tray including a base panel, a front wall, a rear wall, and a pair of side walls, each wall connected to and extending outwardly from the base panel, the base panel including a bottom surface adapted to rest on a seat portion of the walker;
a stabilizer configured to stabilize the holding tray on the seat portion during movement of the walker, the stabilizer including a hook-shaped portion adapted to engage a backrest bar of the walker and a connecting member adapted to join the hook-shaped portion with the rear wall, of the holding tray;
a removable tray insert adapted to be insertable into the holding tray, the removable tray insert including at least one storage compartment adapted to hold at least one of the items to be transported by the walker;
a first set of removable fasteners configured to removably fasten the holding tray to the connecting member of the stabilizer; and
a second set of removable fasteners configured to removably fasten the removable tray insert to the holding tray;
wherein the stabilizer comprises a releasable retainer configured to releasably retain the hook-shaped portion adjacent the backrest bar of the walker;
wherein the releasable retainer comprises
a blocking bar adapted to block the disengagement of the hook-shaped portion from the backrest bar of the walker,
coupled to the connecting member, a socket configured to removably receive a first-end portion of the blocking bar, and
a user-operable threaded fastener adapted to removably fasten a second-end portion of the blocking bar to the hook-shaped portion of the releasable retainer;
wherein the connecting member comprises a storage pocket adapted to store at least one of the items to be transported by the walker;
wherein the base panel is rectangular;
wherein the at least one storage compartment of the removable tray insert comprises a quadrilateral shape;
wherein the removable tray insert comprises at least four storage compartments each one adapted to hold at least one of the items to be transported by the walker;
wherein the pair of side walls comprise opposing outward slopes;
wherein two of the at least four storage compartments of the removable tray insert are each adapted to receive a cylindrical beverage container;
wherein two of the at least four storage compartments of the removable tray insert each comprise recessed compartments having a quadrilateral shape;
wherein the front wall is positioned perpendicularly to the base panel; and
wherein the base panel, the front wall, the rear wall, and the pair of side walls are formed as a single unit.

18. The detachable tray device of claim 17, further comprising set of instructions; and
wherein the detachable tray device is arranged as a kit.

19. A method relating to the use of a detachable tray device, the method comprising the steps of:
providing a holding tray configured to hold items to be transported by the walker, the holding tray including a base panel, a front wall, a rear wall, and a pair of side walls, each wall connected to and extending outwardly from the base panel, the base panel including a bottom surface adapted to rest on a seat portion of the walker;
providing a stabilizer configured to stabilize the holding tray on the seat portion during movement of the walker, the stabilizer including a hook-shaped portion adapted to engage a backrest bar of the walker and a connecting member adapted to join the hook-shaped portion with the rear wall, of the holding tray;
resting the bottom surface of holding tray on the on the seat portion of the walker; and
engaging the hook-shaped portion of the stabilizer on the backrest bar of the walker to stabilize the holding tray on the seat portion during movement of the walker.

20. The method of claim 19, further comprising the steps of:
providing a releasable retainer to releasably retain the hook-shaped portion of the stabilizer adjacent the backrest bar of the walker; and
engaging the releasable retainer to releasably retain the hook-shaped portion of the stabilizer adjacent the backrest bar of the walker.
